(19) United States
(12) Patent Application Publication
(10) Pub. No.: US 2012/0058449 A1
(43) Pub. Date: Mar. 8, 2012

(54) Machined overdenture bar

(75) Inventors: David M. Sklarski, Portsmouth, RI (US); Ronald M. Baggott, Temecula, CA (US)

(73) Assignee: Sterngold Dental, LLC

(21) Appl. No.: 12/807,350

(22) Filed: Sep. 2, 2010

(51) Int. Cl. G05B 19/4097; A61C 8/00

(52) U.S. Cl. 433/173; 700/98

(57) ABSTRACT

Overdenture bars secured to a portion of a jaw bone provide a mounting platform for dental prosthetics. One method to form an overdenture bar includes obtaining a digital image of a portion of a mouth, transferring the image to a computer and forming a three dimensional image of the portion. A virtual overdenture bar is designed to terminate at opposing first and second distal ends and have a first thickness defined by opposing first and second surfaces. The overdenture bar has an extension projecting from at least one distal end adjacent the second surface. Each extension has a second thickness that is less than the first thickness. A socket extends through each extension for engagement with the dental prosthetic. A digital file of the virtual overdenture bar is transferred to a number controlled machine and the overdenture bar and extensions machined from a single piece of stock material.

### CROSS REFERENCE TO RELATED APPLICATION(S)

N.A.

### U.S. GOVERNMENT RIGHTS

N.A.

### BACKGROUND OF THE INVENTION

1. Field

This invention relates to a method for the manufacture of dental prostheses and, more particularly, to a method for machining an overdenture bar.

2. Description of the Related Art

Overdenture bars are secured to a portion of the jaw bone and provide a mounting platform for a dental prosthetic, such as a denture. The assembly provides a more secure fit than adhesively mounted dentures, but the denture may be removed for cleaning or repair. To minimize stress on the underlying bone, that may be painful, the fit between the overdenture bar and the denture is not rigid, but includes some play. Typically, projections on the denture are snap fit to sockets formed in extension portions affixed to distal ends of the overdenture bar. If the denture is not parallel with the overdenture bar, as may happen when the wearer is chewing, the denture may function as a lever and apply excessive stress to an end of the overdenture bar. A socket that reduces this stress is disclosed in U.S. Pat. Nos. 4,540,367 and 5,120,222, both the Sulc. The '367 Patent discloses a metal socket joined to a retention plate. The socket is offset from the plane of a dental fixture to reduce stress on a supporting tooth or implant. A plastic projection affixed to the dental fixture is inserted in the socket locking the fixture in place. The '222 Patent discloses the projection having an hour glass shape and the socket including a convex central portion to provide a snap fit. A stop on one side of socket prevents upward movement of the dental fixture. Tolerances in the socket allow downward shifting without applying pressure on a supporting tooth or implant. Both U.S. Pat. No. 4,540,367 and U.S. Pat. No. 5,120,222 are incorporated by reference herein in their entireties. An exemplary overdenture bar is the ERA® Overdenture Attachment (ERA is a trademark of Sterngold Dental, LLC of Attleboro, Mass.).

Overdenture bars are conventionally manufactured by investment casting, such as the lost wax process. A wax model of the overdenture bar, as dimensioned for a particular patient, is packed in a casting medium, such as casting investment material, contained in a mold. Heating the casting medium causes the wax to melt forming a cavity having the desired dimensions. A molten biocompatible material is then poured into the mold, filling the cavity, and solidified to form the overdenture bar. There are a limited number of biocompatible materials that melt at a reasonable temperature for use in this process. Typically, the overdenture bar is formed from a gold alloy, which is expensive and of moderate strength.

The overdenture bar is, at best, cast to near net shape and finishing is required. The cast bar is sand blasted and hand polished. These steps are dependent on the skill of the dental laboratory technician and introduce variations in the dimensions of the bar. Recovery of precious metal scrap from the sand blasting and polishing media is an additional cost.

Certain dental prostheses are formed by computer aided machining. U.S. Pat. No. 5,092,022 to Duret discloses a process to form a dental prosthesis where a digital image of the implantation zone is obtained, such as by using an optical system (laser), to form a three dimensional image of a mouth. Digital data is provided to a numerically controlled machine. Additional data such as shape and starting material is also provided. The prosthesis is then machined from a block of metal. U.S. Pat. No. 7,322,824 to Schmitt discloses a method to form a dental implant restoration. A surface model of a section of a jaw is formed and a three dimensional digital image of that model generated. A digital toolbox is used to add virtual teeth/brackets to the digital restoration. Computer added design data is transferred to a number controlled mill to machine the restoration. Both U.S. Pat. Nos. 5,092,022 and 7,322,824 are incorporated by reference herein in their entireties.

There remains, however, a need for a process for the manufacture of an overdenture bar that has more accurate dimensions and is less costly than the dental prosthesis described above.

### BRIEF SUMMARY

The details of one or more embodiments of the invention are set forth in the accompanying drawings and the description below. Other features, objects and advantages of the invention will be apparent from the description and drawings, and from the claims.

In a first embodiment, a method to form an overdenture bar is disclosed. This method includes the steps of obtaining a digital image of a portion of a patient's mouth where that overdenture bar is required and transferring the digital image to a computer and forming a three dimensional image of the portion. A virtual overdenture bar having a generally arcuate shape effective for mounting to that portion of the patient's mouth is designed with the overdenture bar terminating at opposing first and second distal ends and having a first thickness that is defined by a first surface and an opposing second surface. The overdenture bar further has an extension projecting from at least one distal end adjacent the second surface. Each extension has a second thickness that is less than the first thickness. Further, a socket extends through each extension for engagement with a dental appliance. A digital file of the virtual overdenture bar is transferred to a number controlled machine and the overdenture bar and each extension is machined from a single piece of stock metallic material.

In a second embodiment, another method to form an overdenture bar is disclosed. This second method includes the steps of obtaining a digital image of a portion of a patient's mouth where the overdenture bar is required, transferring that digital image to a computer and forming a three dimensional image of the portion. A virtual overdenture bar having a generally arcuate shaped mid-portion effective for mounting to that portion of the patient's mouth is designed with the mid-portion bar terminating at opposing first and second distal ends and having a first thickness defined by a first surface and an opposing second surface. At least one virtual extension portion is also designed with a second thickness that is less than the first thickness and having a socket extending through that extension portion. A first digital file of the virtual mid-portion of the overdenture bar is transferred to a first number controlled machine and a second digital file of the extension portion is transferred to a second number controlled machine. The mid-portion of the overdenture bar and the extensions are machined from separate pieces of stock metallic materials and the extensions affixed to distal ends of the mid-portion.

A third embodiment discloses an overdenture bar having a generally arcuate mid-portion with a first thickness defined by opposing first and second surfaces and terminating at opposing first and second distal ends. At least one continuous extension projects from at least one of the distal ends. This extension has a second thickness that is less than the first thickness and also a socket extending through it.

A feature of the first and third embodiments is that when the mid-portion and extensions are formed from a single block of material and a continuous machined product, the overdenture bar is preferably made from a high strength biocompatible material such as titanium or a titanium-base alloy.

A feature of the second embodiment is that when the mid-portion and the extensions are separately formed, the mid-portion is preferably formed from a high strength biocompatible material such as a titanium-base alloy and the extensions from a similar alloy. The extensions are then brazed (welded) to distal ends of the mid-portion.

### BRIEF DESCRIPTION OF THE DRAWINGS

FIG. 1 is a perspective view of an overdenture bar formed in accordance with the disclosed method.

FIG. 2 is a distal extension formed continuous with the overdenture bar in accordance with a first embodiment of the disclosure.

FIG. 3 is a distal extension brazed to the overdenture bar in accordance with a second embodiment of the disclosure.

Like reference numbers and designations in the various drawings indicate like elements.

### DETAILED DESCRIPTION

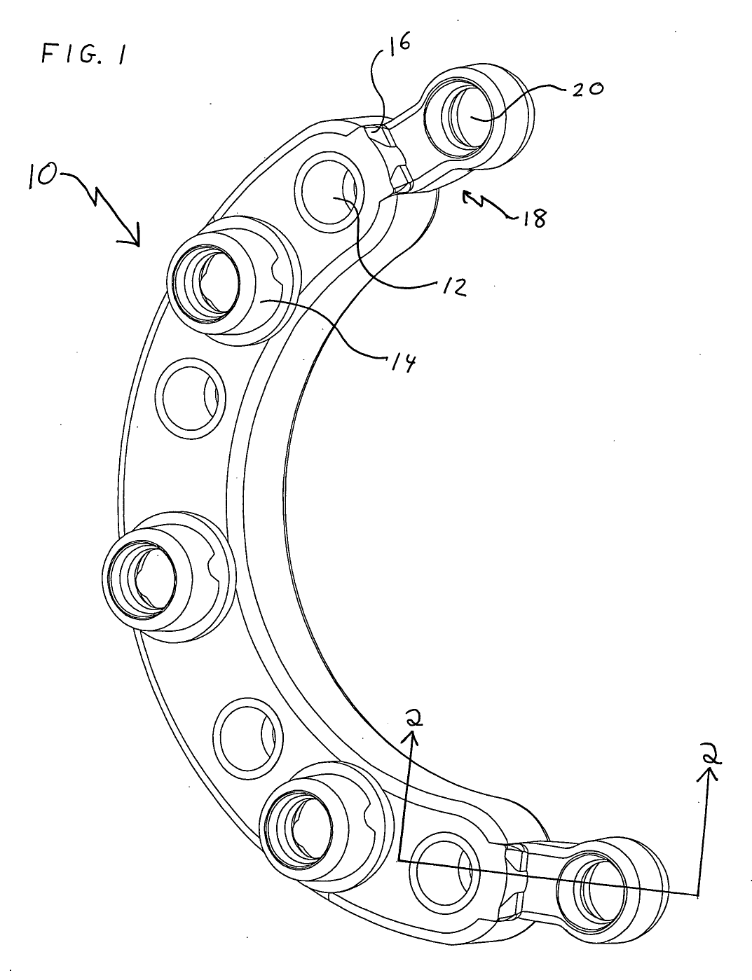

FIG. 1 shows an overdenture bar 10 formed by the process described hereinbelow. The overdenture bar is formed from titanium, a titanium-base alloy or other suitable high strength biocompatible metal or metal alloy. As such, it is biocompatible and less costly than a similarly dimensioned dental prostheses formed from precious metal. It is also lighter weight and has higher strength.

The overdenture bar 10 includes a plurality of apertures 12 that receive screws for rigidly affixing the overdenture bar to a patient's jaw. The apertures 12 are spaced to position the screws into healthy jaw bone and to apply even pressure to the jaw over the length of the overdenture bar 10. Outwardly extending pedestals 14 assist in proper alignment of a dental prosthesis, but do not interfere with up and down motion of that prosthesis. At either, or both, distal ends 16 of the overdenture bar 10 is an extension portion 18 that includes a socket 20. When the extension portion 18 is formed as a continuous portion of the overdenture bar 10, as described below, the socket 20 may be used as a locator for positioning of the overdenture bar. This eliminates the need for a separate locator formed on a centrally disposed portion of the overdenture bar as was required for cast bars having brazed extensions.

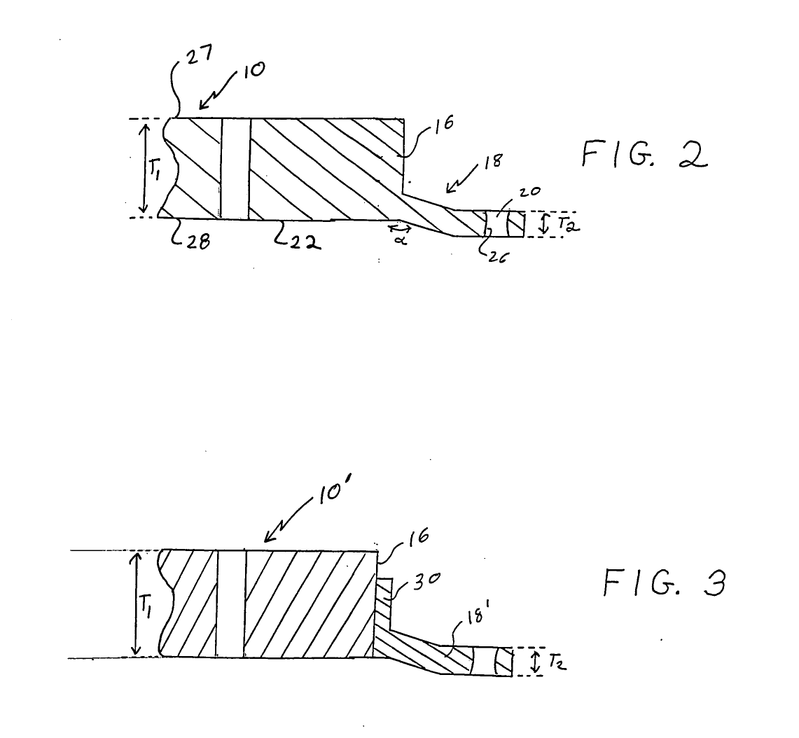

FIG. 2 illustrates section 2-2 of FIG. 1 in cross section. In this first embodiment, the extension portion 18 is continuous with the overdenture bar 10 (only that portion of the overdenture bar 10 adjacent distal end 16 is illustrated in FIG. 2). By continuous, it is meant that the extension end is formed at the same time and from the same single piece of stock material as the overdenture bar, as opposed to being formed separately and affixed to the distal end. By removing a manual affixing step, the dimensional accuracy of the extension portion is greatly increased leading to increased patient comfort and less re-work.

The extension portion 18 is preferably offset by an angle, α, relative to a base plane 22. Typically, 180°−α is on the order of from 3° to 70°. The offset enables a tighter fit, closer to jaw tissue, resulting in less pain for the patient and an improved cosmetic appearance. Socket 20 typically has convex walls 26 to provide a snap fit to a plastic projection extending from a denture as described in U.S. Pat. No. 5,120,222.

This first embodiment, with a continuous extension portion 18, may be formed by first forming a digital image of that portion of a patient's mouth where the overdenture bar 10 is required. The digital image may be taken directly from the patient's mouth, such as by use of a digital three dimensional camera. The digital image is then down loaded to computer aided design (CAD) software, such as CAMbridge™ CAM software available from 3Shape Inc. of New Providence, N.J., and a three dimensional virtual image of that portion of the patient's mouth is formed. A laboratory technician can then form a virtual overdenture bar for approval by a dentist. Referring back to FIG. 1, the virtual overdenture bar 10 has a generally arcuate shape effective for mounting in a patient's mouth and terminates at opposing distal ends 16. At best shown in FIG. 2, the overdenture bar 10 has a first thickness, T₁, defined by opposing first 27 and second 28 surfaces. While the extension portion 18 has a second thickness, T₂, that is less than T₁. Typically, T₁ is between about 2 millimeters and 7 millimeters and T₂ is between about 1.5 millimeters and 1.9 millimeters. A ratio, by thickness, of T₁ to T₂ is from about 1:1 to 5:1.

The three dimensional virtual image is converted into a digital file by the CAD software and transferred to a number controlled machine where the entire overdenture bar 10, including extension portions 18, is machined from a metallic material. This metallic material is a solid block of a high strength biocompatible material, preferably titanium or a titanium-base alloy. By “titanium-base,” it is meant that the alloy contains in excess of 50%, by weight, of titanium. One preferred titanium-base alloy has a nominal composition, by weight, of 90% titanium, 6% aluminum and 4% vanadium. Other high strength biocompatible materials may also be used. Exemplary of these other materials are tantalum and tantalum-base alloys.

There is very little hand craftsmanship required and the machined bar is to a near net finish. The accuracy of the final product is superior in many ways to a cast bar. The use of a non-gold containing, biocompatible titanium-base alloy provides higher strength without the cost of gold.

In a second embodiment, as illustrated in FIG. 3, the extension portion 18′ is formed separately from a generally arcuate mid-portion 10′ of the overdenture bar. The extension portion 18′ includes a flange 30 for affixing, such as by welding, to a sidewall of the distal end 16. The overdenture bar 10 is formed by number controlled machining as described above. As T₂ is considerably less than T₁, the thinner strip of material may be machined to form extension portion 18′. When the extension portion is formed from a separate material from the overdenture bar 10, it is formed from material that is readily welded to the overdenture bar. For example, when the overdenture bar 10 is a titanium-base alloy, the extension portion 18′ is preferably a similar titanium alloy. In this second embodiment, the ratio, by thickness, of T₁ to T₂ is also from about 1:1 to 5:1.

Virtual extension portions 18′ may be designed utilizing CAD software. The dental laboratory technician may either construct a virtual extension portion or select an appropriate extension portion 18′ from a digital library. The digital file for the extension portion is then transferred to an appropriate number controlled machine, such as a laser milling machine, for manufacture of the part.

One or more embodiments of the present invention have been described. Nevertheless, it will be understood that various modifications may be made without departing from the spirit and scope of the invention. For example, other dental and medical prostheses. Accordingly, other embodiments are within the scope of the following claims.

1. A method to form an overdenture bar, comprising the steps of:
obtaining a digital image of a portion of a patient's mouth where said overdenture bar is required;
transferring said digital image to a computer and forming a three dimensional image of said portion;
designing a virtual overdenture bar having a generally arcuate shape effective for mounting to said portion of said patient's mouth, said generally arcuate overdenture bar terminating at opposing first and second distal ends and having a first thickness defined by a first surface and an opposing second surface;
said overdenture bar further having an extension projecting from at least one of said first and second distal ends, each said extension having a second thickness that is less than said first thickness, having a socket extending therethrough and being adjacent said second surface;
transferring a digital file of said virtual overdenture bar to a number controlled machine; and
machining said overdenture bar and each said extension from a single piece of stock metallic material.

2. The method of claim 1 wherein each said extension portion is offset from a plane defined by said second surface.

3. The method of claim 2 wherein said offset is machined to an angle of from 180°-3° to 180°-70°.

4. The method of claim 2 wherein said stock material is selected to be titanium or a titanium-base alloy.

5. The method of claim 4 wherein a ratio of said first thickness to said second thickness is machined to be between 1:1 and 5:1.

6. The method of claim 4 wherein said machining is with a number controlled milling machine.

7. The method of claim 6 including milling a plurality of denture engaging pedestals extending outwardly from said first surface.

8. A method to form an overdenture bar, comprising the steps of:
obtaining a digital image of a portion of a patient's mouth where said overdenture bar is required;
transferring said digital image to a computer and forming a three dimensional image of said portion;
designing a virtual mid-portion of the overdenture bar having a generally arcuate shape effective for mounting to said portion of said patient's mouth, said generally arcuate mid-portion of said overdenture bar terminating at opposing first and second distal ends and having a first thickness defined by a first surface and an opposing second surface;
designing at least one virtual extension having a second thickness that is less than said first thickness and also having a socket extending therethrough;
transferring a first digital file of said virtual mid-portion of said overdenture bar to a first number controlled machine and a second digital file of said at least one virtual extension to a second number controlled machine;
machining said mid-portion of said overdenture bar and each said extension from separate pieces of stock metallic materials; and
affixing each said extension to one of said distal ends.

9. The method of claim 8 wherein said overdenture bar and each said extension are machined from a titanium-base alloy.

10. The method of claim 9 wherein said overdenture bar is milled and each said extension is formed by a processes selected from the group consisting of machining and milling.

11. The method of claim 10 wherein a ratio of said first thickness to said second thickness is machined to be between 1:1 and 5:1.

12. The method of claim 9 wherein said affixing step is by brazing.

13. The method of claim 9 wherein each said extension portion is offset from a plane defined by said second surface.

14. The method of claim 13 wherein said offset is machined to an angle of from 180°-3° to 180°-70°.

15. The method of claim 14 including milling a plurality of denture engaging pedestals extending outwardly from said first surface.

16. An overdenture bar, comprising:
a generally arcuate mid-portion having a first thickness defined by opposing first and second surfaces and terminating at opposing first and second distal ends; and
at least one continuous extension projecting from at least one of said distal ends having a second thickness that is less than said first thickness and a socket extending through each said continuous extension.

17. The overdenture bar of claim 16 wherein a ratio of said first thickness to said second thickness is between 1:1 and 5:1.

18. The overdenture bar of claim 17 wherein each said extension portion is offset from a plane defined by said second surface.

19. The overdenture bar of claim 18 wherein said offset is an angle of from 180°-3° to 180°-70°.

20. The overdenture bar of claim 18 wherein said arcuate mid-portion and said at least one continuous extension are formed from a material selected from the group consisting of titanium and titanium-base alloys.
